(19) United States
(12) Patent Application Publication
(10) Pub. No.: US 2020/0108786 A1
(43) Pub. Date: Apr. 9, 2020

(54) METHOD AND APPARATUS THAT IDENTIFY VEHICLE OCCUPANT

(71) Applicant: GM GLOBAL TECHNOLOGY OPERATIONS LLC, DETROIT, MI (US)

(72) Inventors: Bo Yu, Troy, MI (US); Fan Bai, ANN ARBOR, MI (US); Omer Tsimhoni, BLOOMFIELD HILLS, MI (US); Robert A. Bordo, HARRISON TOWNSHIP, MI (US); Paul E. Krajewski, TROY, MI (US)

(21) Appl. No.: 16/155,080

(22) Filed: Oct. 9, 2018

(51) Int. Cl. B60R 16/037; G06K 9/00; B60W 40/08

(52) U.S. Cl. CPC B60R 16/037; B60W 2040/0809; B60W 40/08; G06K 9/00832

(57) ABSTRACT

A method and apparatus that identify an occupant of a vehicle are provided. The method includes: receiving information from a mobile device of a person approaching a vehicle, inputting feature information, corresponding to the received information and vehicle sensor information, into at least one support vector machine model and storing at least one score output by the at least one support vector machine model, identifying the person approaching the vehicle based on the at least one score, determining a seating location of the identified person approaching the vehicle based on the feature information, and adjusting settings of the vehicle based on a profile of the identified person approaching the vehicle and the seating location.

Apparatuses and methods consistent with exemplary embodiments relate to identifying a vehicle occupant. More particularly, apparatuses and methods consistent with exemplary embodiments relate to identifying a vehicle occupant as the occupant approaches a vehicle.

### SUMMARY

One or more exemplary embodiments provide a method and an apparatus that identify a vehicle occupant based on information provided by a mobile device. More particularly, one or more exemplary embodiments provide a method and an apparatus that use a support vector machine model corresponding to a vehicle occupant to identify the occupant as the occupant approaches a vehicle.

According to an aspect of exemplary embodiment, a method that identifies an occupant of a vehicle is provided. The method includes receiving information from a mobile device of a person approaching a vehicle, inputting feature information, corresponding to the received information and vehicle sensor information, into at least one support vector machine model and storing at least one score output by the at least one support vector machine model, identifying the person approaching the vehicle based on the at least one score, determining a seating location of the identified person approaching the vehicle based on the feature information, and adjusting settings of the vehicle based on a profile of the identified person approaching the vehicle and the seating location.

The receiving information from the mobile device of the person approaching the vehicle may include receiving one or more from among Wi-Fi ranging information, Bluetooth radio signal strength and angle of arrival information, pedometer information, accelerometer information, pose information, and gyroscopic information.

The vehicle sensor information may include one or more from among key fob presence information, key fob position information, door status information, seat sensor information, and camera-based occupancy information.

The inputting the received feature information may include inputting the received feature information into a plurality of support vector machine models and storing a plurality of scores output by the plurality of support vector machine models.

The identifying the person approaching the vehicle based on the at least one score may include identifying the person based on the plurality of scores.

The storing the plurality of scores output by the plurality of support vector machine models may include storing the plurality of scores in a matrix, wherein each of the plurality scores in the matrix is associated with a support vector machine model, profile information and a mobile device.

The at least one support vector machine model may include information associating a mobile device to profile information of a person.

The support vector machine model may include at least one of a regression support vector machine model and a classification support vector machine model.

The method may include detecting adjustments to the settings of the vehicle made by the identified person, and updating the profile of the identified person with the adjustments to the settings of the vehicle.

The method may include training the at least one support vector machine model corresponding to the identified person based on the feature information.

According to an aspect of an exemplary embodiment, an apparatus that identifies an occupant of a vehicle is provided. The apparatus includes: at least one memory comprising computer executable instructions; and at least one processor configured to read and execute the computer executable instructions. The computer executable instructions causing the at least one processor to receive information from a mobile device of a person approaching a vehicle, input feature information, corresponding to the received information and vehicle sensor information, into at least one support vector machine model and store at least one score output by the at least one support vector machine model, identify the person approaching the vehicle based on the at least one score, determine a seating location of the identified person approaching the vehicle based on the feature information an adjust settings of the vehicle based on a profile of the identified person approaching the vehicle and the seating location.

The computer executable instructions may cause the at least one processor to receive information including one or more from among Wi-Fi ranging information, Bluetooth radio signal strength and angle of arrival information, pedometer information, accelerometer information, pose information, and gyroscopic information.

The vehicle sensor information may include one or more from among key fob presence information, key fob position information, door status information, seat sensor information, and camera-based occupancy information.

The computer executable instructions may cause the at least one processor to input the received feature information into a plurality of support vector machine models and store a plurality of scores output by the plurality of support vector machine models.

The computer executable instructions may cause the at least one processor to identify the person approaching the vehicle based on the plurality of scores.

The computer executable instructions may cause the at least one processor to store the plurality of scores in a matrix, and each of the plurality scores in the matrix may be associated with a support vector machine model, profile information and a mobile device.

The at least one support vector machine model may include information correlating to a mobile device to profile information of a person.

The support vector machine model may include at least one of a regression support vector machine model and a classification support vector machine model.

The computer executable instructions may cause the at least one processor to detect adjustments to the settings of the vehicle made by the identified person, and update the profile of the identified person with the adjustments to the settings of the vehicle.

The computer executable instructions may cause the at least one processor to train the at least one support vector machine model corresponding to the identified person based on the feature information.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that identifies an occupant of a vehicle according to an exemplary embodiment;

FIG. 2 shows an illustrative diagram of a system that identifies an occupant of a vehicle according to an exemplary embodiment;

FIG. 3 shows a flowchart for a method that identifies an occupant of a vehicle according to an exemplary embodiment; and

FIGS. 4A and 4B show examples of a structure of a score matrix and support vector machine models corresponding to mobile devices and profiles according to aspects of an exemplary embodiment.

### DETAILED DESCRIPTION OF EXEMPLARY EMBODIMENTS

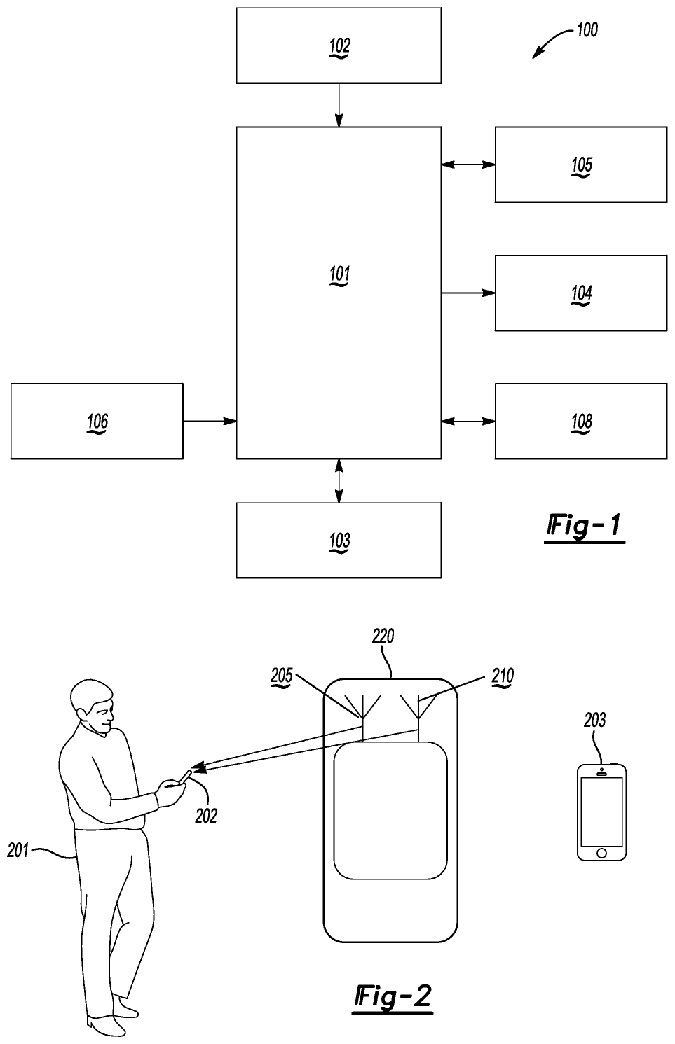

An apparatus and method that identify an occupant of a vehicle will now be described in detail with reference to FIGS. 1-4B of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

As vehicles are being increasingly shared and with the spread of mobile smart devices, such as mobile phones, there is an opportunity to use information provided by mobile devices to customize or enhance an experience of a person entering a vehicle. Generally, identification of a person and or settings corresponding to a person may be sent directly from a mobile device of a person or may be loaded when the mobile device is detected in or near the vehicle. However, when there are multiple mobile devices or when multiple persons use the same mobile device, there is difficulty in determining the identity of the person and/or loading the appropriate settings. Thus, a vehicle must identify a person from among multiple users of a mobile device and/or adjust or load vehicle settings based on information provided by a selected mobile device from among multiple mobile devices that may be approaching a vehicle.

FIG. 1 shows a block diagram of an apparatus that identifies an occupant of a vehicle 100 according to an exemplary embodiment. As shown in FIG. 1, the apparatus that identifies an occupant of a vehicle 100, according to an exemplary embodiment, includes a controller 101, a power supply 102, a storage 103, an output 104, vehicle settings and controls 105, a user input 106, and a communication device 108. However, the apparatus that identifies an occupant of a vehicle 100 is not limited to the aforementioned configuration and may be configured to include additional elements and/or omit one or more of the aforementioned elements. The apparatus that identifies an occupant of a vehicle 100 may be implemented as part of a vehicle, as a standalone component, as a hybrid between an on vehicle and off vehicle device, or in another computing device.

The controller 101 controls the overall operation and function of the apparatus that identifies an occupant of a vehicle 100. The controller 101 may control one or more of a storage 103, an output 104, vehicle settings and controls 105, a user input 106, and a communication device 108 of the apparatus that identifies an occupant of a vehicle 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the vehicle settings and controls 105, the user input 106, and the communication device 108 of the apparatus that identifies an occupant of a vehicle 100. The information may be sent and received via a bus or network, or may be directly read or written to/from one or more of the storage 103, the output 104, the vehicle settings and controls 105, the user input 106, and the communication device 108 of the apparatus that identifies an occupant of a vehicle 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the vehicle settings and controls 105, the user input 106, and the communication device 108, of the apparatus that identifies an occupant of a vehicle 100. The power supply 102 may include one or more from among a battery, an outlet, a capacitor, a solar energy cell, a generator, a wind energy device, an alternator, etc.

The storage 103 is configured for storing information and retrieving information used by the apparatus that identifies an occupant of a vehicle 100. The storage 103 may be controlled by the controller 101 to store and retrieve information received from the communication device 108. The information may include information from a mobile device received via communication device 108, information corresponding to a support vector machine, information corresponding to a scoring matrix, vehicle sensor information. The storage 103 may also include the computer instructions configured to be executed by a processor to perform the functions of the apparatus that identifies an occupant of a vehicle 100.

The information received from a mobile device may include one or more from among Wi-Fi ranging information, Bluetooth radio signal strength and angle of arrival information, pedometer information, accelerometer information, pose information, and gyroscopic information. The vehicle sensor information may include one or more from among key fob presence information, key fob position information, door status information, seat sensor information, and camera-based occupancy information.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that identifies an occupant of a vehicle 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an indicator light, etc.

The output 104 may output notification including one or more from among an audible notification, a light notification, and a display notification. The notification may include information notifying of a value of a vehicle setting or that a vehicle setting is being adjusted. In addition, the output 104 may display a message for the identified person at an appropriate location in the vehicle.

The vehicle settings and controls 105 may include controls configured to adjust seat and steering wheel settings, climate control settings, infotainment settings, mirror settings, etc. The seat and steering wheel settings may include one or more of seating position, height, tilt, steering wheel height, steering wheel position, etc. The climate control settings may include one or more of heated or cooled seats or steering wheel, cabin temperature, fan speed, etc. The infotainment settings may include one or more of a volume setting, a channel setting, or playing a song or video at an appropriate display or speaker. The vehicle settings and controls 105 may be configured to provide vehicle sensor information corresponding to the aforementioned vehicle settings and controls as well as one or more from among key fob presence information, key fob position information, and door status information.

The user input 106 is configured to provide information and commands to the apparatus that identifies an occupant of a vehicle 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc.

The user input 106 may be configured to receive a user input to acknowledge or dismiss the notification output by the output 104. The user input 106 may also be configured to receive a user input to adjust a vehicle setting. The adjusted vehicle setting may then be stored in storage along with a corresponding profile and a support vector machine model may be updated based on the adjustment to the vehicle setting.

The communication device 108 may be used by apparatus that identifies an occupant of a vehicle 100 to communicate with several types of external apparatuses according to various communication methods. The communication device 108 may be used to send/receive information from a wireless device. For example, the communication device 108 may send/receive information to connect a wireless device to a vehicle sharing system, authorize a wireless device with the vehicle sharing system, and enable access to vehicle by enabling an authentication device after authorizing the wireless device.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

The communication device 108 can be used as both a communication device and a ranging sensor, especially with some recent communication protocols, such as IEEE 802.11mc. When packets are being exchanged between the communication device 108 and a mobile device (such as a smartphone), Time-of-Flight can be measured and precise distance between the communication device 108 and the mobile device can be determined. This distance information can be utilized to determine the relative position between the vehicle and a vehicle occupant.

According to an exemplary embodiment, the controller 101 of the apparatus that identifies an occupant of a vehicle 100 may be configured to receive information from a mobile device of a person approaching a vehicle, input feature information into at least one support vector machine model and store at least one score output by the at least one support vector machine model, identify the person approaching the vehicle based on the at least one score, determine a seating location of the identified person approaching the vehicle based on the feature information, and adjust settings of the vehicle based on a profile of the identified person approaching the vehicle and the seating location. The feature information may include data transformed from the information received from the mobile device and vehicle sensor information to a format that may be processed by the support vector machine model.

The controller 101 of the apparatus that identifies an occupant of a vehicle 100 may be configured to receive information including one or more from among Wi-Fi ranging information, Bluetooth radio signal strength and angle of arrival information, pedometer information, accelerometer information, pose information, and gyroscopic information.

The controller 101 of the apparatus that identifies an occupant of a vehicle 100 may also be configured to input the received feature information into a plurality of support vector machine models and store a plurality of scores output by the plurality of support vector machine models. The controller 101 of the apparatus that identifies an occupant of a vehicle 100 may be configured to identify the person approaching the vehicle based on the plurality of scores.

In addition, the controller 101 of the apparatus that identifies an occupant of a vehicle 100 may be configured to control to store the plurality of scores in a matrix, wherein each of the plurality scores in the matrix is associated with a support vector machine model, profile information and a mobile device.

Further, the controller 101 of the apparatus that identifies an occupant of a vehicle 100 may also be configured to detect adjustments to the settings of the vehicle made by the identified person, and update the profile of the identified person with the adjustments to the settings of the vehicle. The controller 101 of the apparatus that identifies an occupant of a vehicle 100 may also be configured to train the at least one support vector machine model corresponding to the identified person based on the feature information.

FIG. 2 shows an illustrative diagram of a system that identifies an occupant of a vehicle according to an exemplary embodiment. Referring to FIG. 2, a vehicle 220 the apparatus that identifies an occupant of a vehicle 100 including two or more Wi-Fi access points 205, 210. A person 201 approaching vehicle 220 may have a first mobile device 202 that performs range measurements with access points 205, 210, or both on vehicle 220, and then provides vehicle 220 with the range measurements as well as other mobile device information via a wireless link. Another mobile device 203 may also be near the vehicle 220 and/or approaching the vehicle 220 and information from mobile device 203 may also be received by the apparatus that identifies an occupant of a vehicle 100 in vehicle 220.

The apparatus that identifies an occupant of a vehicle 100 may generate feature information from the received information and input feature information into support vector machine models that output scores. The scores may then be used to identify a person, a profile corresponding to the person and a seating location of a person inside of the vehicle.

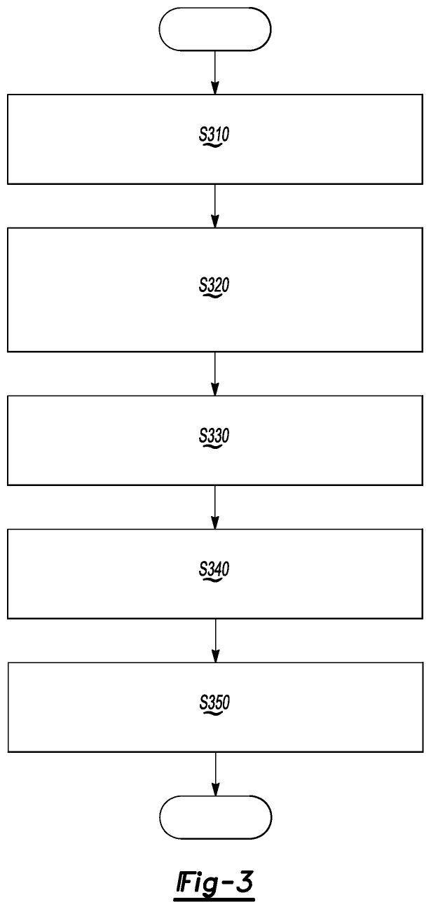

FIG. 3 shows a flowchart for a method that identifies an occupant of a vehicle according to an exemplary embodiment. The method of FIG. 3 may be performed by the apparatus that identifies an occupant of a vehicle 100 or may be encoded into a computer readable medium as instructions that are executable by a computer to perform the method.

Referring to FIG. 3, information from a mobile device of a person approaching a vehicle is received in operation S310. In operation S320, feature information corresponding to the received information and vehicle sensor information is input into at least one support vector machine model and at least one score output by the at least one support vector machine model is stored.

In operation S330, the person approaching the vehicle is identified based on the at least one score. Then, a seating location of the identified person approaching the vehicle is determined based on the feature information in operation S340. The settings of the vehicle based on a profile of the identified person approaching the vehicle and the seating location are adjusted in operation S350.

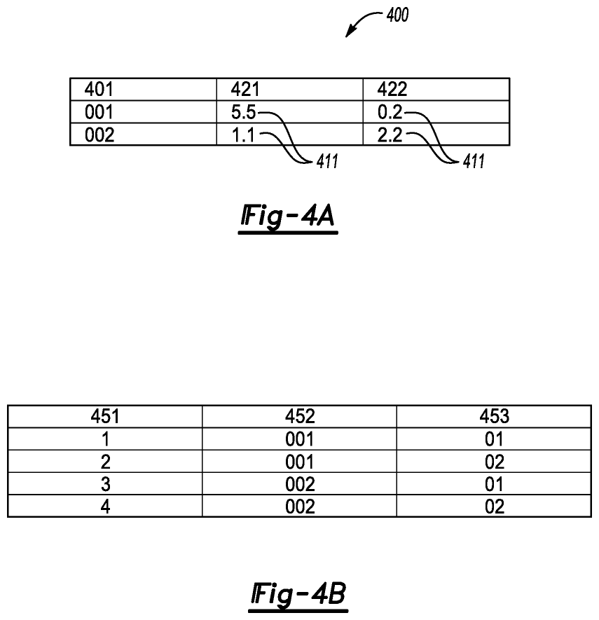

FIGS. 4A and 4B show examples of a structure of a score matrix and a support vector machine models corresponding to mobile devices and profiles according to an aspect of an exemplary embodiment.

Referring to FIG. 4A, a matrix 400 of scores 411 is shown. The matrix includes a first column 401 listing a mobile device and corresponding user, a second column 421 showing scores that result when feature information received from a mobile device and vehicle is input into support vector machine models corresponding to a first mobile device and a profile of a first user and a second mobile device and a profile of a first user, and a third column 422 showing scores that result when feature information received from a mobile device and vehicle is input into support vector machine models corresponding to a first mobile device and a profile of a second user and a second mobile device and a profile of a second user.

Referring to FIG. 4B, support vector machine models 451 corresponding to mobile devices 452 and a profile 453 are maintained in storage 103. The support vector machine models 451 may be executed with feature information as input and may output scores 411 that are used to identify an occupant and select a profile corresponding to the identified occupant.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method that identifies an occupant of a vehicle, the method comprising:
receiving information from a mobile device of a person approaching a vehicle;
inputting feature information, corresponding to the received information and vehicle sensor information, into at least one support vector machine model and storing at least one score output by the at least one support vector machine model;
identifying the person approaching the vehicle based on the at least one score;
determining a seating location of the identified person approaching the vehicle based on the feature information; and
adjusting settings of the vehicle based on a profile of the identified person approaching the vehicle and the seating location.

2. The method of claim 1, wherein the receiving information from the mobile device of the person approaching the vehicle comprises receiving one or more from among Wi-Fi ranging information, Bluetooth radio signal strength and angle of arrival information, pedometer information, accelerometer information, pose information, and gyroscopic information.

3. The method of claim 2, wherein the vehicle sensor information comprises one or more from among key fob presence information, key fob position information, door status information, seat sensor information, and camera-based occupancy information.

4. The method of claim 3, wherein the inputting the received feature information comprises inputting the received feature information into a plurality of support vector machine models and storing a plurality of scores output by the plurality of support vector machine models.

5. The method of claim 4, wherein the identifying the person approaching the vehicle based on the at least one score comprises identifying the person based on the plurality of scores.

6. The method of claim 5, wherein the storing the plurality of scores output by the plurality of support vector machine models comprises storing the plurality of scores in a matrix, wherein each of the plurality scores in the matrix is associated with a support vector machine model, profile information and a mobile device.

7. The method of claim 1, wherein the at least one support vector machine model comprises information associating a mobile device to profile information of a person.

8. The method of claim 1, wherein the support vector machine model comprises at least one of a regression support vector machine model and a classification support vector machine model.

9. The method of claim 1, further comprising:
detecting adjustments to the settings of the vehicle made by the identified person; and
updating the profile of the identified person with the adjustments to the settings of the vehicle.

10. The method of claim 1, further comprising training the at least one support vector machine model corresponding to the identified person based on the feature information.

11. An apparatus that identifies an occupant of a vehicle, the apparatus comprising:
at least one memory comprising computer executable instructions; and
at least one processor configured to read and execute the computer executable instructions, the computer executable instructions causing the at least one processor to:
receive information from a mobile device of a person approaching a vehicle;
input feature information, corresponding to the received information and vehicle sensor information, into at least one support vector machine model and store at least one score output by the at least one support vector machine model;
identify the person approaching the vehicle based on the at least one score;
determine a seating location of the identified person approaching the vehicle based on the feature information; and
adjust settings of the vehicle based on a profile of the identified person approaching the vehicle and the seating location.

12. The apparatus of claim 11, wherein the computer executable instructions cause the at least one processor to receive information including one or more from among Wi-Fi ranging information, Bluetooth radio signal strength and angle of arrival information, pedometer information, accelerometer information, pose information, and gyroscopic information.

13. The apparatus of claim 12, wherein the vehicle sensor information comprises one or more from among key fob presence information, key fob position information, door status information, seat sensor information, and camera-based occupancy information.

14. The apparatus of claim 13, wherein the computer executable instructions cause the at least one processor to input the received feature information into a plurality of support vector machine models and store a plurality of scores output by the plurality of support vector machine models.

15. The apparatus of claim 14, wherein the computer executable instructions cause the at least one processor to identify the person approaching the vehicle based on the plurality of scores.

16. The apparatus of claim 15, wherein the computer executable instructions cause the at least one processor to store the plurality of scores in a matrix, and
wherein each of the plurality scores in the matrix is associated with a support vector machine model, profile information and a mobile device.

17. The apparatus of claim 11, wherein the at least one support vector machine model comprises information correlating to a mobile device to profile information of a person.

18. The apparatus of claim 11, wherein the support vector machine model comprises at least one of a regression support vector machine model and a classification support vector machine model.

19. The apparatus of claim 11, wherein the computer executable instructions cause the at least one processor to:
detect adjustments to the settings of the vehicle made by the identified person; and
update the profile of the identified person with the adjustments to the settings of the vehicle.

20. The apparatus of claim 11, wherein the computer executable instructions cause the at least one processor to train the at least one support vector machine model corresponding to the identified person based on the feature information.
